(19) United States
(12) Patent Application Publication
(10) Pub. No.: US 2023/0263091 A1
(43) Pub. Date: Aug. 24, 2023

(54) SELF LOADING VEGETABLE HARVESTER

(71) Applicant: William Paul Franzoy, Demming, NM (US)

(72) Inventor: William Paul Franzoy, Demming, NM (US)

(21) Appl. No.: 17/652,059

(22) Filed: Feb. 22, 2022

(51) Int. Cl. A01D 33/10

(52) U.S. Cl. CPC A01D 33/10

(57) ABSTRACT

A root vegetable harvesting system for transporting, filling, and depositing filled storage crates. The harvesting system includes a non-labor intensive collecting system for loading harvested crop into containers, while in the field, directly from the harvester. The containers are picked-up or loaded onto the collecting system by the harvesting system, moved in relation to the collecting system by the collecting system to a location where the containers are filled with crop, and are released from the collecting system by the collecting system.

### BACKGROUND

Typically, bulb onions are harvested by uprooting them with a breaker bar that is pulled in the soil beneath the onions thereby uprooting the onions and bringing them to the surface of the soil. Often, the leafy tops of these uprooted onions are cut before the onions are collected and removed from the field.

Machines for harvesting and processing onions and other root vegetables, such as potatoes, turnips, etc., have been known for a long time in various designs of pull-behind devices or self-propelled machines. In these devices or machines, lifting devices lift several rows of crops (often with soil and rocks from the field) are used with a downstream conveying system. There are numerous designs of these harvesting machines, for improving the harvesting, cleaning and sorting, and packaging, all which utilize various arrangements of components. These components include complex conveying systems arranged downstream of the harvesting systems. Many of these designs are such that the crop is dispensed into a wagon which transports the harvested crop to an off-the-field facility.

What has not been designed, until now, is an economical, non-labor intensive system for collecting the harvested crop from the field.

### SUMMARY

The present disclosure provides a harvesting system that includes a non-labor intensive collecting system for loading harvested crop such as vegetables, but also fruit and nuts, into crates, cartons, bins, boxes, totes, and similar containers, while in the field, directly from the system of the harvester that collects the crop from off of the ground. The collecting system enables an increase of the overall harvesting performance by automating the pick-up, positioning, and release of the containers before, during, and after filling with the crop by a dispensing system of the harvester, all while the harvesting system is moving in the field.

In one particular implementation, this disclosure provides a vegetable crop harvesting system that includes a crop harvester and a collecting system, the collecting system loading the crop harvested by the harvester into containers. The containers are picked-up or loaded onto the collecting system by the system, moved in relation to the collecting system by the collecting system to a location where the containers are filled with crop, and are released from the collecting system by the collecting system. The collecting system has a frame structure configured to receive at least one container thereon, the collecting system having, in order, an inclined pick-up section, a loading section, and a release section, the inclined pick-up section having wall rails, support rails, and a conveyor mechanism, the loading section having support rails and a conveyor mechanism, and the release section having support rails moveable from a first position to a second lowered position.

In another particular implementation, this disclosure provides a vegetable harvesting system for root vegetables comprising a crop harvester, a crop dispensing system, and a collecting system. The crop harvester has a first end and an opposite second end, with a digger portion at the first end and a conveyor mechanism extending from proximate the digger portion to the second end. The crop dispensing system is positioned proximate the second end of the crop harvester, and has a chute with a chute conveyor and an exit. The collecting system is located proximate the chute exit and has a frame structure configured to receive at least one container thereon. The collecting system has, in order, an inclined pick-up section, a loading section, and a release section. The inclined pick-up section has wall rails, support rails, and a conveyor mechanism, the loading section has support rails and a conveyor mechanism, and the release section has support rails moveable from a first position to a second lowered position. Each of the conveyor mechanism of the inclined pick-up section, the conveyor mechanism of the loading section, and the support rails of the release section is connected to a control station on the harvesting system.

In another particular implementation, this disclosure provides a method of collecting harvesting root crop in a field. The method includes providing a harvested crop to a chute having a floor conveyor and an exit; positioning a first container on an elevated loading section of a frame structure proximate the chute exit, the first container having been provided to the elevated loading section from an inclined pick-up section of the frame structure; filling the first container with the harvested crop via the chute exit; after filling the first container, activating a conveyor mechanism in the loading section to move the first container to a support rail of a release section; and after moving the first container to the release section, moving the support rail of the release section from a first position to a second position and lowering the first container.

### BRIEF DESCRIPTION OF THE FIGURES

The disclosure may be more completely understood in consideration of the following detailed description of various embodiments of the disclosure in connection with the accompanying drawing, in which:

FIG. 1 is a side view of a harvesting system connected to a tractor, the harvesting system having a crop harvester and a collecting system.

FIG. 2A is a left side view of the harvesting system; FIG. 2B is a right side view of the harvesting system.

FIG. 3 is a front view of a portion of the harvester of the harvesting system.

FIG. 4 is a perspective view of a harvesting system, in use, being pulled by a tractor, the harvesting system having a crop harvester and a collecting system.

FIG. 5 is another perspective view of the harvesting system, in use, highlighting alignment of containers for use with the collecting system.

FIG. 6 is another perspective view of the harvesting system, in use, highlighting advancement of the harvesting system in relation to the containers for use with the collecting system.

FIG. 7 is another perspective view of the harvesting system, in use, highlighting filling of the containers by the collecting system.

FIG. 8 is another perspective view of the harvesting system, in use, highlighting movement of the containers by the collecting system.

### DETAILED DESCRIPTION

As indicated above, the present disclosure is directed to harvesting system, such as for root vegetables or other vegetables, fruits, nuts, and other crops, that includes an automated collecting system for picking-up, positioning, and releasing containers before, during, and after filling of the containers with the crop by a dispensing system of the harvester, all while the harvesting system is moving in the field. The harvesting system includes the harvester, which collects the crop from the ground and transports the crop to the collecting system, which provides the containers that receive the harvested crop.

In the following description, reference is made to the accompanying drawing that forms a part hereof and in which is shown by way of illustration at least one specific implementation. The following description provides additional specific implementations. It is to be understood that other implementations are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples, including the figures, provided below. In some instances, a reference numeral may have an associated sub-label consisting of a lower-case letter to denote one of multiple similar components. When reference is made to a reference numeral without specification of a sub-label, the reference is intended to refer to all such multiple similar components.

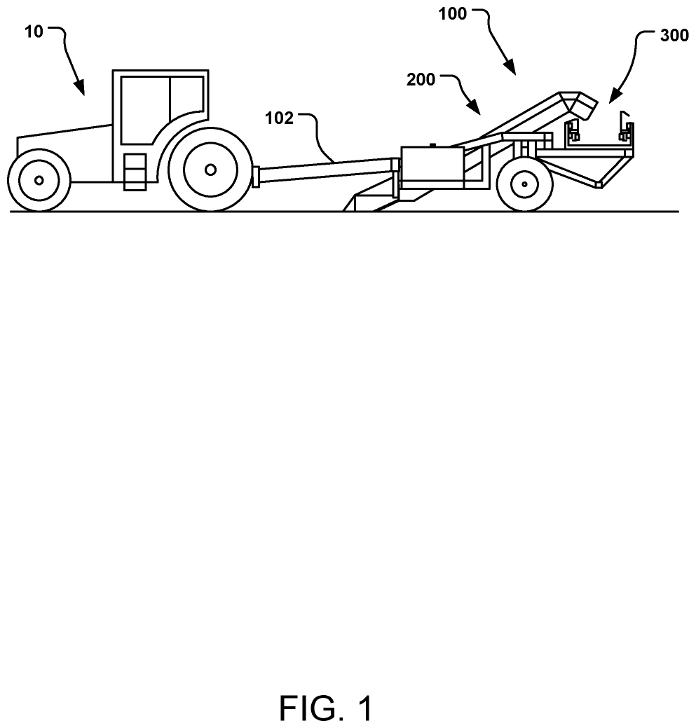

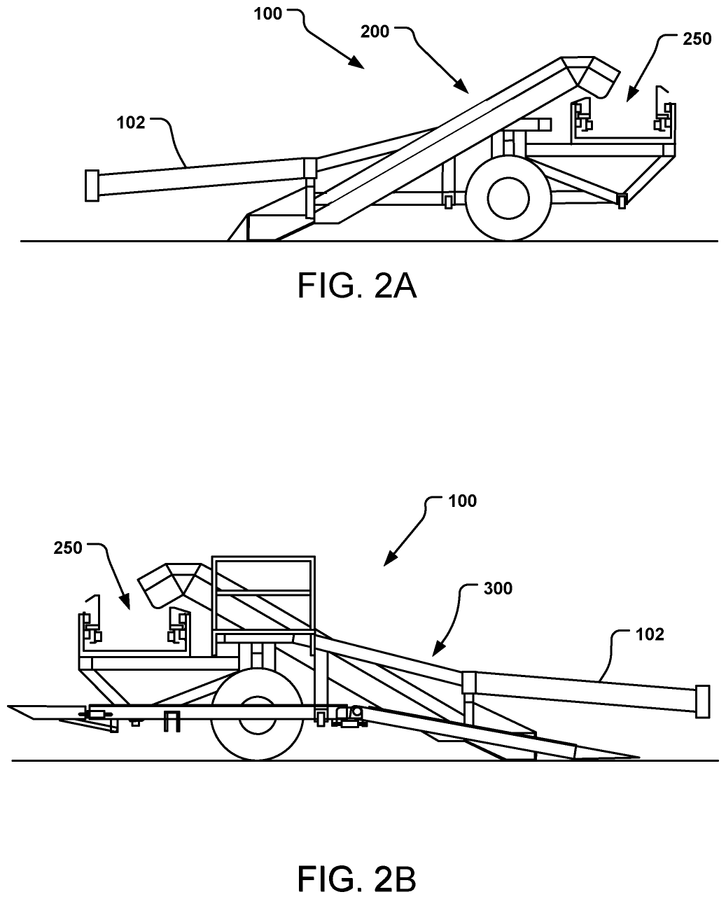

Turning to the figures, FIG. 1 generically shows a tractor 10 operably connected to a harvesting system 100 that has a crop harvester 200 and a collecting system 300. The crop harvester 200 is located on the left side of the harvesting system 100 and the collecting system 300 is located on the right side of the harvesting system 100, in relation to the tractor 10. Thus, FIG. 2A shows the left side of the harvesting system 100, focusing on the crop harvester 200 of the harvesting system 100, as the collecting system 300 is located behind the harvester 200 in this view. FIG. 2B shows the right side of the harvesting system 100, focusing on the collecting system 300 of the harvesting system 100, as the harvester 200 is located behind the collecting system 300 in this view.

As seen in FIGS. 1, 2A and 2B, the harvesting system 100 is a pull-behind implement, connected to the tractor 10 via its draw bar or other hitch. The various systems of the harvesting system 100 can be powered by the tractor's power-take-off (PTO), the tractor's hydraulic system, or by a hydraulic or electrical system isolated on the harvesting system 100.

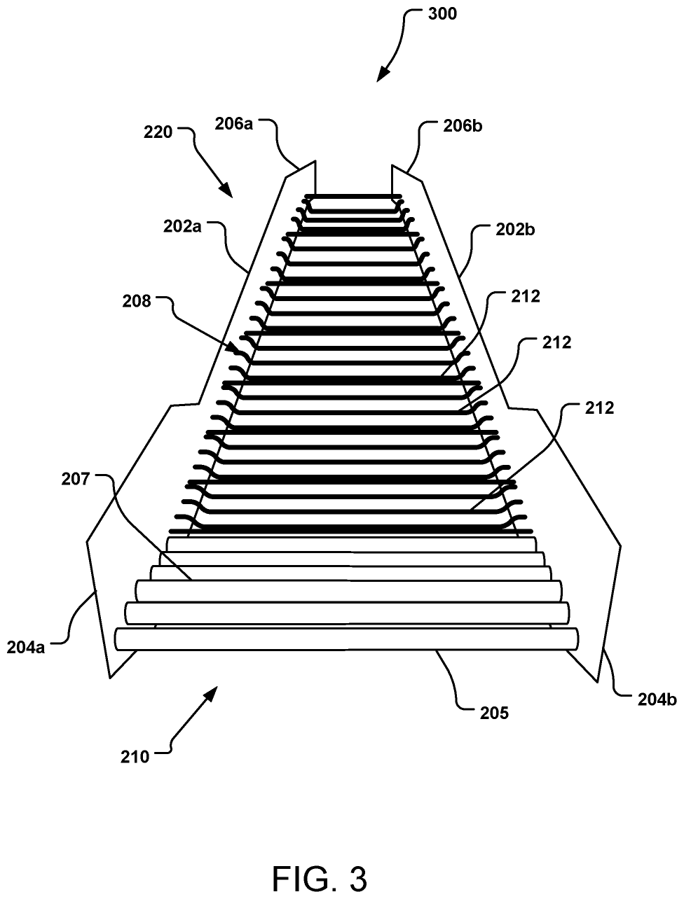

The crop harvester 200 of the harvesting system 100, in this particular design, collects onions that have been previously uprooted, optionally topped, and placed into rows on the ground. The harvester 200 includes a subsystem that collects the onions from the ground and a subsystem that elevates the onions from the ground level, while separating the onions from dirt and rocks. The harvester 200, in general, includes a collection point that includes a roller, bar, or other shovel-type element that collects the onions from the ground. Additional details regarding the harvester 200 and the collection point are described in reference to FIG. 3, below. The harvesting system 100 also includes a crop dispensing system 250, which in this particular design, collects the onions from the harvester 200 and dispenses them into a container provided by the collecting system 300. In this design, the dispensing system 250 includes a conveyor belt running transverse from the harvester 200 to a dispenser which dispenses the onions into containers provided by the collecting system 300.

In the particular design of FIGS. 1, 2A and 2B, the crop harvester 200 is located on the left side of the harvesting system 100 and the collecting system 300 is located on the right side of the harvesting system 100, when viewed as attached to a power source, such as the tractor 10, with the crop dispensing system 250 transferring the onions from the left side to the right side, when operating.

As indicated above, the harvesting system 100 is a pull-behind implement, supported by tires, and connected to the tractor 10 by an arm 102, which can be connected to the tractor 10 by conventional means, such as a draw bar or hitch. A PTO shaft may connect the harvesting system 100 to the tractor 10, the PTO shaft generally extending next to the arm 102. The arm 102 may have running through it or against it any power lines, such as hydraulic lines.

The harvesting system 100 may be at least partially collapsible, foldable, or pivotable to a width to allow the harvesting system 100 to be transported on a road, or the harvesting system 100 may be able to be broken into multiple components, such as for transport or storage. Additionally or alternately, the harvesting system 100 may be design to separate the collecting system 300 from one or both of the harvester 200 and the dispensing system 250, for example, to use the collecting system 300 with a different harvesting system. Alternative designs of the harvesting system 100 and variations thereof may be self-propelled.

A portion of the crop harvester 200 is illustrated in FIG. 3, particularly, the lower subsystem 210 of the harvester 200 which collects the onions from the ground and the upper subsystem 220 which transports the onion to the crop dispensing system 250, while separating the onions from dirt and rocks. The lower subsystem 210, in general, includes a collection point that includes a roller, bar, or other shovel-type element that collects the onions from the ground. Additional details regarding the harvester 200 and the collection point are described below.

Shown in FIG. 3 is the lower subsystem 210 and the upper subsystem 220 of the harvester 200. There is no definite separation or delineation between the lower subsystem 210 and the upper subsystem 220, but rather, the subsystems 210, 220 are general portions or regions of the harvester 200.

Parallel rails 202a, 202b define an inclined ramp that extends from the lower subsystem 210 to the upper subsystem 220 and includes both subsystems 210, 220. The rails 202 extend from the ground up to the dispensing system 250, the rails 202a, 202b having a first end 204a, 204b, respectively, at the ground that forms the first end of the harvester 200 and a second end 206a, 206b, respectively that forms the second end of the harvester 200 and that terminates at or proximate to the dispensing system 250. The construction at the first end 204 collects the previously uprooted onions off of the ground. At the first end 204, extending between the rails 202, is a digger bar 205 set back from the end 204 of the rails 202, which in use, is configured to reside below the onions to be collected; in other words, the first ends 204 and the digger bar 205 plow into the ground when the harvester 200 is moving along the ground. The digger bar 205 may be, e.g., wedge shaped, square or rectangular, or rounded. Positioned behind the digger bar 205 is at least one rod 207, in this particular design, five rods 207. Any or all of the digger bar 205 and the rods 207 may be stationary or may rotate about their longitudinal axis extending between the rails 202; the rods 207, in particular, may be roller bars. The digger bar 205 and the rods 207 are part of the lower subsystem 210 of the harvester 200.

Positioned behind the rods 207 is a conveyor 208, formed by multiple parallel, spaced apart bars 212 connected in relation to each other and moved by a chain, cable, or other transport mechanism along the rails 202. This conveyor 208 is part of the upper subsystem 220 of the harvester 200. The bars 212 may be evenly spaced the length of the conveyor 208 or may have a spacing pattern. The conveyor 208 is a continuous loop, which when energized, for example by the tractor PTO, runs upward to the second end 206 of the rails 202. The particular design of the harvester 200 of these figures has two parallel conveyors 208, each with a digger bar 205 and rods 207, extending inclined to a single dispensing system 250.

In use, as the harvesting system 100 and thus the crop harvester 200 move along the rows of previously uprooted onions, the first end 204 and the digger bar 205 plow into the ground under the onions, so that the onions are lifted over the digger bar 205 and onto the rods 207 (roller bars); the onions are pushed over the rods 207 towards the conveyor 208 by the subsequently fed onions. After passing over the rods 207, the onions are collected by the bars 212 of the inclined conveyor 208 and are transported up the incline to the second end 206 of the harvester 200 to the dispensing system 250.

Both the rods 207 and the bars 212 of the conveyor 208 have a spacing therebetween, the spacing less than the diameter of the smallest onion to be collected. Dirt, small rocks, and small onions fall between adjacent rods 207 and bars 212 as the onions are conveyed toward the dispensing system 250.

The portion of the crop harvester 200 shown in FIG. 3 is appropriately supported by and mounted on a frame, e.g., a wheeled frame, as seen in FIGS. 1 and 2A, at an appropriate incline. As indicated above, the harvester 200 collects the harvested crop from the ground and moves it to the dispensing system 250, which passes it to the collecting system 300.

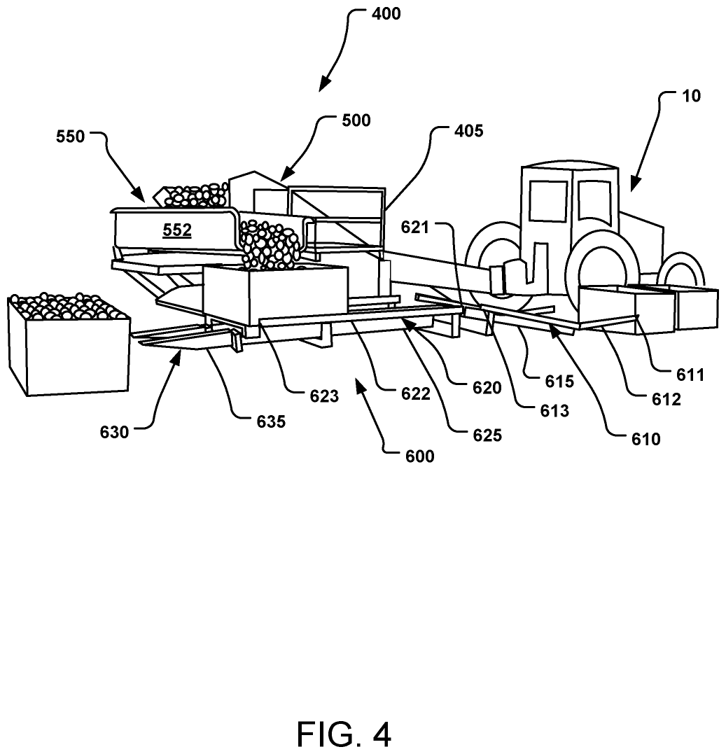

Moving on, FIGS. 4 through 8 illustrate a harvesting system 400 being pulled by the tractor 10 and in use, collecting and packaging previously uprooted onions. The harvesting system 400, similar to the harvesting system 100, has a crop harvester 500 that collects onions that have been previously uprooted and placed into rows, a crop dispensing system 550 that moves and dispenses the collected onions into containers provided by a collecting system 600. It is to be understood that various features and/or details from the harvesting system 100 and any of the systems and subsystems, described above, may be applied to this harvesting system 400 unless contrary to the construction.

The harvesting system 400 includes a user or operator station 405, which includes a platform and steps leading to the platform. An operator may sit or stand at the station 405. At the station 405 is a control panel with controls for various systems of the harvesting system 400; for example, the control panel can control the conveyor belt of the harvester 500 that moves the onions up the incline (see, e.g., FIG. 3), it can control the flow of onions in the dispensing system 550, and/or it can control the movement of containers onto, on, and off of the collecting system 600 by controlling (optionally, independently) the conveyor mechanisms of the various sections of the collecting system 600. The various systems of the harvesting system 400 can be powered by the tractor's power-take-off (PTO), the tractor's hydraulic system, or by a hydraulic or electrical system isolated on the harvesting system 400. In some designs, one or more of the conveyor mechanisms of the various sections of the collecting system 600 may be ground driven. The controls at the operator station 405 may be any suitable type, including electrical, pneumatic, hydraulic, or mechanical.

In FIG. 4, the upper subsystem of the crop harvester 500, the crop dispensing system 550 and the collecting system 600 are readily seen. The various features and/or details of the upper subsystem of the crop harvester 500, the crop dispensing system 550 and the collecting system 600 are similar to or the same as the harvesting system 100 and any of the systems, described above. Additional details regarding the dispensing system 550 and the collecting system 600, compared to the dispensing system 250 and the collecting system 300, are provided here.

As indicated above and as seen in all of FIGS. 4-8, the crop dispensing system 550 receives onions from the end of the conveyor of the upper subsystem of the harvester 500; the onions fall off of the moving conveyor into the dispensing system 550. The dispensing system 550 includes a chute 552 that collects the onions deposited from the upper subsystem of the harvester 500. An open top chute is preferred, to increase the collection accuracy from the upper subsystem.

In this design of the harvesting system 400 and the crop harvester 500, the chute 552 of the crop dispensing system 550 extends orthogonal to the conveyor, from the left side of the harvesting system 400 to the right side. The chute 552 includes side walls and a bottom with a conveyor belt, which moves the deposited onions towards the collecting system 600, in this this design from the left side to the right side of the dispensing system 550 and the harvesting system 400. The chute 552 is closed at the left side to inhibit loss of onions off that end of the chute 552. The right side of the chute 552 is open, providing an exit for the onions from the chute 552. In some designs, a gate or door may be present at the exit to stop the movement of the onions off the conveyor belt and out of the chute 552.

A user or operator can control the flow of onions in and out from the chute 552 into container(s) by controlling the conveyor belt at the bottom of the chute 552, e.g., by one or more hydraulic lines. From the chute 552, the onions are deposited into a container such as a crate, carton, bin, tote, or box that has been provided by the collecting system 600. During filling, the container is supported by the collecting system 600.

Referring to all of FIGS. 4-8, the collecting system 600 has three sections, a pick-up section 610, a loading section 620, and a release section 630. In the pick-up section 610, containers are picked-up or collected from the ground and moved towards the loading section 620, where the containers are loaded with the crop from the chute 552 of the dispensing system 550. From the loading section 620, the containers are dropped from the collecting system 600 by the release section 630. In this design, the pick-up section 610, the loading section 620, and the release section 630 are longitudinally aligned, with the pick-up section 610 closest to the plowing end (the first end 204) of the harvester. In these figures, two parallel conveyor ramps of the crop harvester 500 are seen.

The collecting system 600, overall, is a frame-like structure, formed from a plurality of rails or bars; for durability of the system 600, the frame-like structure is metal. Each section, the pick-up section 610, the loading section 620, and the release section 630, may be separable from the other section(s) or may be permanently affixed together. The rails or bars from one section may be continuous to another section, or a discernable break may be seen. Similarly, the conveyor mechanism(s) of one section may be continuous to another section or may be individual conveyor mechanism(s).

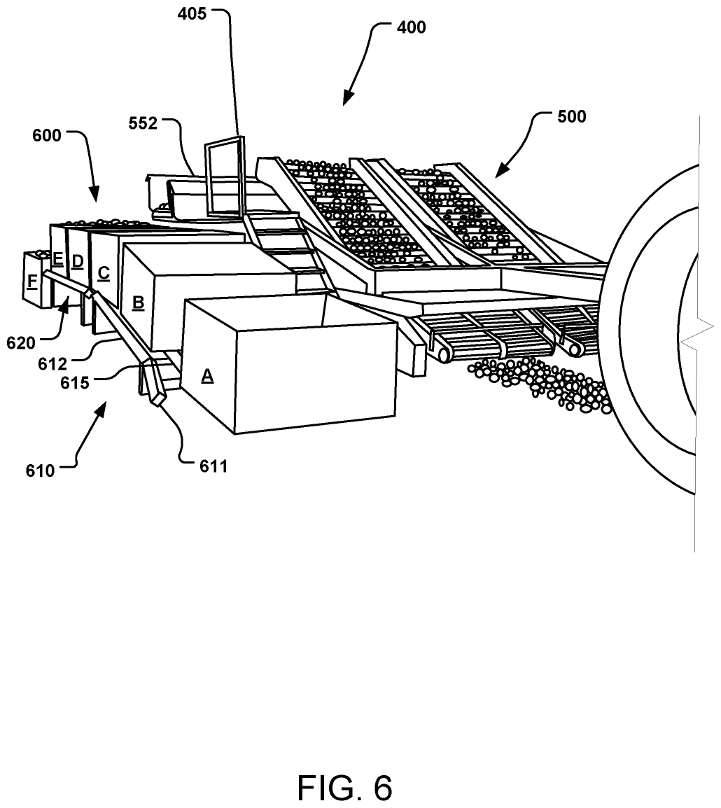

Best seen in FIG. 4 and FIG. 6, the pick-up section 610 has a pair of rails 612 having a first end 611 and a second end 613. The rails 612 have a narrowest distance therebetween that is sufficient to receive a container therein; that is, the rails 612 are spaced to allow a container to pass therebetween. The rails 612 are connected to appropriate cross bracing and/or longitudinal bracing that forms a solid and secure frame structure. This frame structure includes sufficient bracing to form a floor or base to support the containers thereon, with the rails 612 forming outer walls to retain the containers on the frame structure. As indicated, this frame structure includes floor or support rails to support the containers thereon, in this particular design, a pair of support rails 615 extending longitudinally to at least partially form a floor.

From the first end 611 to the second end 613 of the wall rails 612, the rails 612 are not parallel, but at the first end 611 form an inlet region that tapers toward the second end 613 after which the rails 612 are parallel; in other designs, the wall rails 612 may be non-parallel their entire length. This inlet region guides and aligns the containers to be received on the support rails 615 between the wall rails 612. It is noted that the first end 611 of the wall rails 612 may extend past the support rails 615, allowing the wall rails 612 to align a container prior to the container being engaged by the support rails 615.

As one moves from the inlet region of the pick-up section 610 toward the second end 613 of the wall rails 612, the support rails 615 elevate off the ground, at an incline, with the wall rails 612 elevating at the same rate; thus, for the wall rails 612, the second end 613 is higher than the first end 611. Typically, the wall rails 612 and the support rails 615 elevate at the same rate, so that the rails 612, 615 are essentially parallel.

The pick-up section 610 may include a conveyor mechanism of some type proximate the support rails 615 to facilitate movement of the containers from the first ends 611 to the second end 613. The conveyor mechanism may be, e.g., a belt or a chain with teeth to engage with the container and move the container along the rails 612, 615, e.g., up the incline.

From the second end 613, the wall rails 612 progress to the loading section 620. Similarly, the support rails 615 progress to the loading section 620.

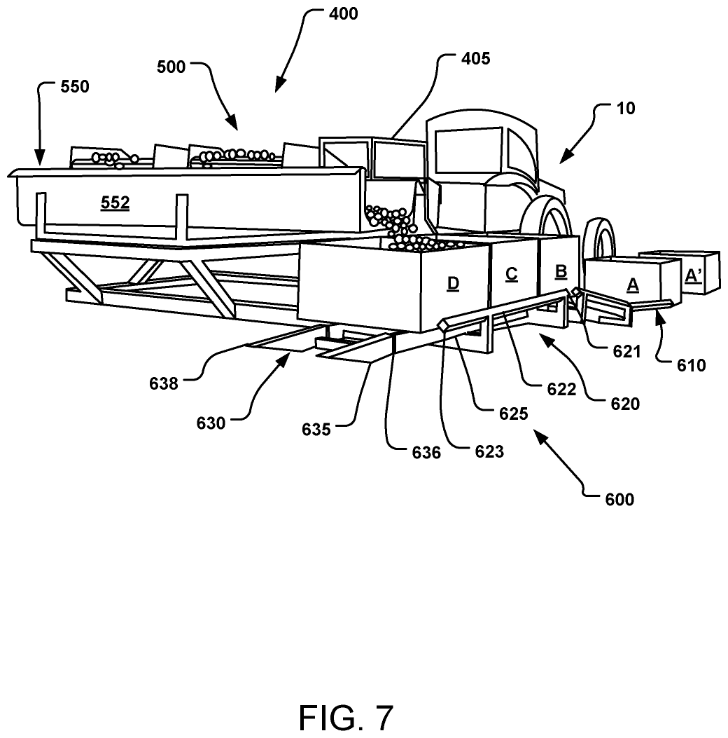

The loading section 620, best seen in FIG. 4 and FIG. 7, has a pair of wall rails 622 having a first end 621 and a second end 623. The wall rails 622 have a narrowest distance therebetween that is sufficient to receive a container therein; that is, the rails 622 are spaced to allow a container to pass therebetween. From the first end 621 to the second end 623 of the wall rails 622, the rails 622 are parallel to allow a container to pass between the rails 622. The wall rails 622 may have the same spacing as the wall rails 612 of the pick-up section 610. The rails 612 are connected to appropriate cross bracing and/or longitudinal bracing that forms a solid and secure frame structure. This frame structure includes sufficient bracing to form a floor or base to support the containers thereon, with the rails 622 forming outer walls to retain the containers on the frame structure. This frame structure includes support rails 625 to support the containers thereon. The wall rails 622 and the support rails 625 are essentially parallel.

The loading section 620 may include a conveyor mechanism of some type proximate the support rails 625 to facilitate movement of the containers from the first end 621 to the second end 623. The conveyor mechanism may be, e.g., a belt or a chain with teeth to engage with the container and move the container along the rails 625.

From the second end 623, the wall rails 622 and support rails 625 progress to the release section 630.

The release section 630, best seen in FIG. 4 and FIG. 7, has a pair of support rails 635 that support a container. The support rails 635 have a first end 636 and a second end 638 that forms the distal most end of the collecting system 600. In the particular design shown, the release section 630 does not have wall rails, but other designs may include wall rails.

The support rails 635 are hinged at the first end 636, so that they pivot downward towards the ground; that is, the second end 638 pivots or otherwise moves toward the ground. The hinge may be positioned between the first end 636 of the support rails 635 and the second end of the support rails 625 of the loading section 620. The pivoting allows a container supported on the rails 635 to be released on to the ground less abruptly than if the container fell from a higher height.

The collecting system 600, in this design, is integral with the harvester 500 to form the harvesting system 400. In other designs, the collecting system 600 may be modular, able to be connected or attached to the harvester 500 or to other harvesting equipment for use and removed when desired. The collecting system 600 can be used with other harvesting equipment other than a root vegetable harvester and even with any equipment. For example, the collecting system 600 to move the containers can be used with any equipment that repeatedly fills containers.

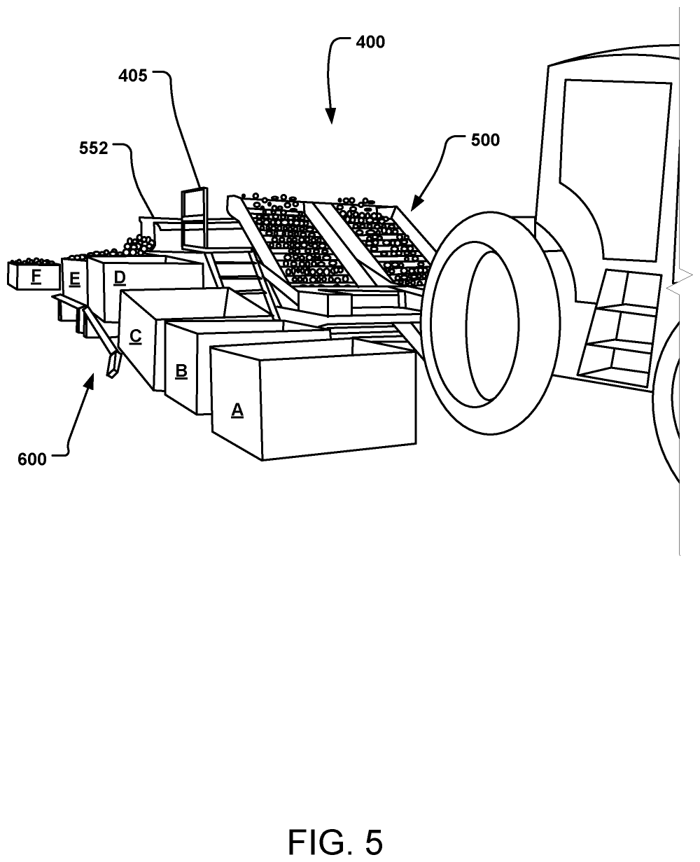

FIGS. 5-8 show approximately step-wise a process for using the harvesting system 400, particularly, the various movements of containers, the acting on by the collecting system 600 on those containers, and of a crop (particularly, onions in this example) being loaded into those containers. During the steps shown in these figures, the tractor 10 with the harvesting system 400 is slowly moving forward, continuously collecting onions from the ground and loading them into containers.

In FIG. 5, a row of containers A, B, C, D, E, F are shown. These containers have various status: containers A and B are positioned on the ground next to the path of the tractor ready to be picked-up by the pick-up section 610, container C is at least partially aligned by the wall rails of the pick-up section 610, container D is on the support rails of the loading section 620, container E is on the support rails of the loading section 620 being filled with crop, and filled container F is on the ground, having been released by the release section 630. The containers, e.g., at least containers A, B, C which are yet to be picked-up and already picked-up containers D, E, F, are or were properly spaced away from the row of onions or other crop on the ground and are or were arranged in a sufficiently straight line so that the harvesting system 400 can pick-up both the onions and containers without needing to stop. The containers were delivered to and placed on the ground after the uprooting and optional topping of the onions.

In FIG. 5, onions are being deposited into container E by a conveyor or similar moving mechanism in the chute 552 of the dispensing system 550. The container E is supported in the loading section 620, directly under the exit from the chute 552.

In FIG. 6, after the container E is sufficiently full, the flow of onions is stopped. The flow of onions is controlled by controls (e.g., levers, switches, etc.) located at the user or operator station 405. Although the particular design of the collecting system 600 and the dispensing system 550 has the controls manually operated, other designs may have appropriate sensors (e.g., visual sensor(s), weight sensor(s)) and automatic switches to start and stop the flow of the onions. The movement of the containers is also controlled at the operator station 405; the operator station 405 has controls for the conveyor, belt, or other movement mechanisms of the pick-up section 610, the filling section 620, and the release section 630, including the hinge in the support rail 635. The movement mechanisms of the pick-up section 610 and the filling section 620 can be controlled individually, as well as the release section 630.

The conveyor or other movement mechanism in the loading section 620 is activated to move the filled container E out from under the chute 552 and bring in the empty container D to under the chute 552. The filled container E moves to the release section 630, where the container E is dropped to the ground. The user or operator controls the release of the containers from the operator station 405, e.g., by activating one or more controls that activate the pivoting of the support rail 635 in the release section 630.

The container C is brought up the incline of the pick-up section 610 and is staged on the loading section 620. The container B is partially up the incline of the pick-up section 610 and the container A is next in line to be engaged. This progression of containers C, B, and A is due to the tractor continuously moving forward slowly.

In FIG. 7, the container D is under the chute 552 of the dispensing system 550 and is being filled with onions from the chute 552. The container C is staged on the loading section 620 with the container B. Container A is next in line to be engaged by the pick-up section 610 and a new container A′ has come into view. The container E is no longer on the frame of the collecting system 600, having been dropped from the frame by the hinged support rails 635. The tractor with the harvesting system 400 has traveled forward sufficiently far that the filled containers F and E are no longer in the scene.

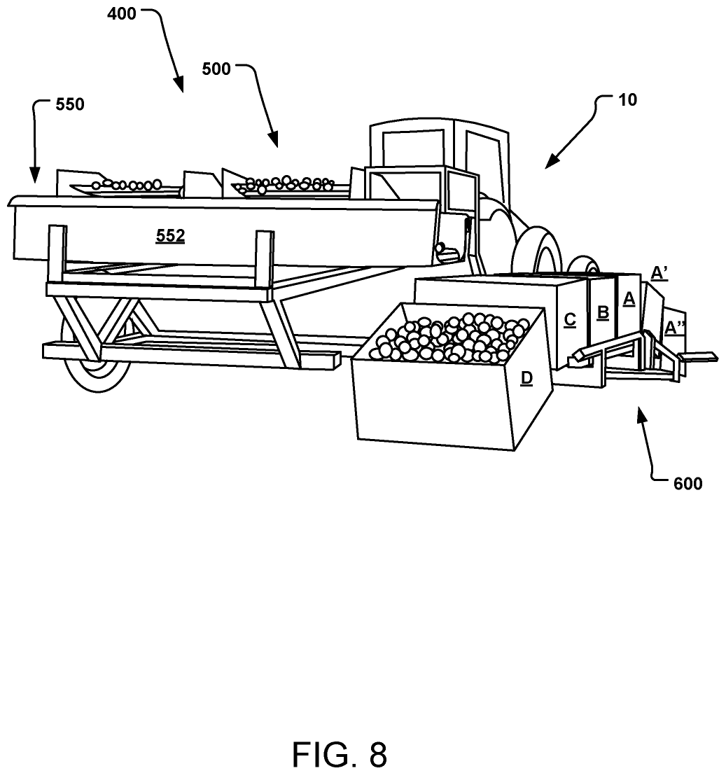

In FIG. 8, the flow of onions is stopped and the now-full container D is shown in the process of being released by the release section 630. The container C is positioned under the chute 552 and the containers B and A are staged on the loading section 620. The container A′ is partially up the incline of the pick-up section 610 and a new container A″ is engaged by the pick-up section 610.

If the volume of onions collected off the ground is not sufficient to fill all the provided containers, one or more empty containers may be released from the loading section 620 without being filled. For example, in FIG. 8, container C may be released by the release section 630 without being filled, so that the container B is the next container filled.

In such a manner, the harvesting system 400, having the collecting system 600, allows a methodology for crating or packaging crops with minimal manual intervention. The harvesting system 400 includes the crop harvester 500 which collects the crop, e.g., from the ground, and the crop dispensing 550 that transports the crop from the harvester 500 to containers provided by the collecting system 600. The collecting system 600 inhibits the need to manually load or queue empty containers, manually move the queued containers, and manually unload full containers. The empty containers merely need to be provided to the field, placed on the ground, being harvested, and the filled containers are picked-up, e.g., by a fork lift. In some instances, the filled containers may be released to a wagon, truck, or other transport mechanism rather than being released to the ground.

The above specification and examples provide a complete description of the structure and use of exemplary implementations of the invention. The above description provides specific implementations. It is to be understood that other implementations are contemplated and may be made without departing from the scope or spirit of the present disclosure. Elements of one implementation may be mixed and matched with elements from another implementation unless to the contrary. The above detailed description, therefore, is not to be taken in a limiting sense. While the present disclosure is not so limited, an appreciation of various aspects of the disclosure will be gained through a discussion of the examples provided.

Unless otherwise indicated, all numbers expressing feature sizes, amounts, and physical properties are to be understood as being modified by the term “about,” whether or not the term “about” is immediately present. Accordingly, unless indicated to the contrary, the numerical parameters set forth are approximations that can vary depending upon the desired properties sought to be obtained by those skilled in the art utilizing the teachings disclosed herein.

As used herein, the singular forms “a”, “an”, and “the” encompass implementations having plural referents, unless the content clearly dictates otherwise. As used in this specification and the appended claims, the term “or” is generally employed in its sense including “and/or” unless the content clearly dictates otherwise.

Spatially related terms, including but not limited to, “bottom,” “lower”, “top”, “upper”, “beneath”, “below”, “above”, “on top”, “on,” etc., if used herein, are utilized for ease of description to describe spatial relationships of an element(s) to another. Such spatially related terms encompass different orientations of the device in addition to the particular orientations depicted in the figures and described herein. For example, if a structure depicted in the figures is turned over or flipped over, portions previously described as below or beneath other elements would then be above or over those other elements.

What is claimed is:

1. A crop harvesting system for root vegetables comprising:
a crop harvester having a first end and an opposite second end, with a digger portion at the first end and a conveyor mechanism extending from proximate the digger portion to the second end;
a crop dispensing system positioned proximate the second end of the crop harvester, the dispensing system having a chute with a chute conveyor and a chute exit,
a collecting system located proximate the chute exit, the collecting system comprising a frame structure configured to receive at least one container thereon, the collecting system having, in order, an inclined pick-up section, a loading section, and a release section,
the inclined pick-up section having wall rails, support rails, and a conveyor mechanism;
the loading section having support rails and a conveyor mechanism; and
the release section having support rails moveable from a first position to a second lowered position,
each of the conveyor mechanism of the inclined pick-up section, the conveyor mechanism of the loading section, and the support rails of the release section connected to a control station on the harvesting system.

2. The harvesting system of claim 1, wherein the conveyor mechanism of the harvester is an inclined conveyor from the digger portion to the second end.

3. The harvesting system of claim 1, wherein the chute of the dispensing system extending orthogonal to the conveyor mechanism of the crop harvester.

4. The harvesting system of claim 1, wherein the loading section of the collecting system includes wall rails.

5. The harvesting system of claim 4, wherein the wall rails of the loading section are parallel.

6. The harvesting system of claim 1, wherein the support rails of the release section are hinged to move from the first position to the second lowered position.

7. The harvesting system of claim 1, wherein the wall rails of the pick-up section are not parallel.

8. The harvesting system of claim 1, wherein the conveyor mechanism of the inclined pick-up section, the conveyor mechanism of the loading section, and the support rails of the release section are independently controlled.

9. The harvesting system of claim 1, wherein the conveyor mechanism of the inclined pick-up section and the conveyor mechanism of the loading section have chains.

10. A method of collecting harvesting root crop in a field, the method comprising:
providing a harvested crop to a chute having a floor conveyor and a chute exit;
positioning a first container on an elevated loading section of a frame structure proximate the chute exit, the first container having been provided to the elevated loading section from an inclined pick-up section of the frame structure;
filling the first container with the harvested crop via the chute exit;
after filling the first container, activating a conveyor mechanism in the loading section to move the first container to a support rail of a release section; and
after moving the first container to the release section, moving the support rail of the release section from a first position to a second position and lowering the first container.

11. The method of claim 10, wherein moving the support rail of the release section from a first position to a second position comprises pivoting the support rail from the first position to the second position.

12. The method of claim 10, wherein positioning the first container on an elevated loading section comprises moving the container from the inclined pick-up section with a conveyor mechanism.

13. The method of claim 12, where the conveyor mechanism is a chain.

14. The method of claim 10 further comprising:
positioning a second container on the elevated loading section proximate the chute exit, the second container having been provided to the elevated loading section from the inclined pick-up section;
filling the second container with the harvested crop via the chute exit;
after filling the second container, activating the conveyor mechanism in the loading section to move the second container to the support rail of the release section; and
after moving the second container to the release section, moving the support rail of the release section from the first position to the second position and lowering the second container.

15. The method of claim 14 further comprising:
positioning a third container on the elevated loading section proximate the chute exit, the second container having been provided to the elevated loading section from the inclined pick-up section;
filling the third container with the harvested crop via the chute exit;
after filling the third container, activating the conveyor mechanism in the loading section to move the third container to the support rail of the release section; and
after moving the third container to the release section, moving the support rail of the release section from the first position to the second position and lowering the third container.
